(19) United States
(12) Patent Application Publication
(10) Pub. No.: US 2012/0265609 A1
(43) Pub. Date: Oct. 18, 2012

(54) AUTHENTICATED ADVERTISEMENT PLATFORM

(75) Inventors: Arnaud Robert, Burbank, CA (US); Gregory Thomas Brandeau, Burbank, CA (US)

(73) Assignee: Disney Enterprises, Inc., Burbank, CA (US)

(21) Appl. No.: 13/086,342

(22) Filed: Apr. 13, 2011

(51) Int. Cl. G06Q 30/00

(52) U.S. Cl. 705/14.49

(57) ABSTRACT

The present disclosure describes methods and systems for distributing an online advertisement based on a digital certificate received by an advertising platform server. The advertising platform server may validate the digital certificate. In addition, the advertising platform server may determine an advertisement class based on the digital certificate. Based on the determined advertisement class, the advertising platform server may select an advertisement for presentation to a user.

### BACKGROUND

Online advertising has become an important marketing channel for companies selling various goods and services and/or promoting causes. In the typical online advertising scenario, a user receives content and is presented with an advertisement, such as a banner ad, skyscraper ad, pop-up ad, or in-content ad. Various systems have been developed to distribute advertisements to users. A common example is a user requesting content over a network such as the Internet in the form of a web page or web resource and receiving the content with advertisements included.

Online advertisements may be distributed in several ways. For instance, an advertiser may directly transmit advertisements to a destination website for presentation to users. Increasingly, however, advertisers are choosing to indirectly distribute their advertisements through online advertising agencies and advertising platform services. Online advertising agencies are typically intermediaries that redistribute advertisements to advertising platform services. For example, an online advertising agency may receive advertisements from an advertiser and subsequently distribute the advertisements to several different advertising platform services. In some instances, online advertising agencies may additionally or alternatively distribute advertisements to other advertising agencies. As a result, a single advertisement may be passed downstream several times prior to reaching an advertising platform service. Advertising platform services are typically entities that store advertisements from multiple sources and distribute the stored advertisements to a network of destination websites.

While the aforementioned distribution scheme allows advertisements to quickly reach a wide audience, it may also make controlling where advertisements appear very difficult. Currently, many advertisers employ blacklists to an average list of websites that are not able to display their advertisements. In particular, an advertiser will typically transmit (either directly, or indirectly through advertising agencies) a blacklist to each of its associated advertising platform services. Each advertising platform service then checks the blacklist before distributing an advertisement to a website. While website blacklists provide some degree of control, they are not particularly effective. For example, website operators often avoid blacklists by simply changing their Internet domains. Furthermore, because blacklists are often passed among several entities, the actual blacklists that are used may not always be up to date. Lastly, blacklists are not scalable and, thus, may be complicated to manage across large organizations.

As a result, advertisers frequently find their advertisements displayed on websites that cause damage to the advertiser's financial position and/or reputation. Accordingly, what is needed in the art is an advertisement distribution system that enables advertisers to effectively manage and control the websites on which their advertisements appear.

### BRIEF SUMMARY

In view of the foregoing, systems and methods are provided for distributing advertisements based on digital certificates.

In one implementation, a method for distributing advertisements over a network to which computer devices can connect, includes: receiving an advertisement request including a digital certificate from a requestor that is a computer server or another device that presents content and advertisements to viewers; validating the digital certificate; selecting an advertisement based on the digital certificate; and providing the selected advertisement in an electronic form to the requestor.

In some variations, the method can further include receiving metadata associated with at least one advertisement. The selecting can be based on the metadata. The metadata can include advertisement class information. The method can further include: receiving at least one advertisement request from a second requestor that does not include a digital certificate; selecting an advertisement from a default set of advertisements; and providing the advertisement in an electronic form to the second requestor. The advertisements in the default set can be flagged as not requiring a digital certificate to be included in an advertisement request. Selecting the advertisement can include: determining an advertisement class from a set of advertisement classes based on the digital certificate; and selecting an advertisement approved for the determined advertisement class. Determining the advertisement class can include identifying the advertisement class based on information provided by the digital certificate. Determining an advertisement class can include: determining a certificate type for the digital certificate; and identifying an advertisement class based on the certificate type. Determining the advertisement class can include identifying the advertisement class based on classification information provided by the digital certificate. At least one class in the set of advertisement classes can be based on the Motion Picture Association of America movies ratings system. The selecting can further include selecting based on information about a website with which the digital certificate is associated. The digital certificate can be formatted according to the X.509 standard. The method can further include receiving advertisement data from an advertisement distribution server, wherein the advertisement data includes at least one advertisement and metadata associated with the at least one advertisement. The selecting can be further based on the metadata associated with the at least one advertisement. The advertisement distribution server is associated with an advertiser or an advertising agency. The metadata includes digital certificate criteria information.

### BRIEF DESCRIPTION OF THE DRAWINGS

FIG. 1 is a block diagram of an advertisement distribution system according to one embodiment of the present invention.

FIG. 2 is a block diagram of a subsystem of the advertisement distribution system of FIG. 1.

FIG. 3 is an exemplary web page showing example placement locations of online advertisements according to one embodiment of the present invention.

FIG. 4 is a flow diagram of a process for distributing an online advertisement to a web server based on a digital certificate according to an embodiment of the present invention.

FIG. 5 is a flow diagram of a process for requesting and receiving online advertisements according to an embodiment of the present invention.

FIG. 6 is a block diagram of exemplary subsystems or components according to one embodiment of the present invention.

### DETAILED DESCRIPTION OF THE INVENTION

In the following description, for the purposes of explanation, numerous specific details are set forth in order to provide a thorough understanding of the present invention. It will be apparent, however, to one skilled in the art that the present invention may be practiced without some of these specific details.

The present disclosure describes methods and systems for distributing an online advertisement based on a digital certificate received by an advertising platform server. In a very specific embodiment, a user having a computer with a browser uses the browser to request content, over a network, from a web server. The web server then determines the suitable content to respond with, requests advertising content from an advertising platform server, combines the advertising content with the requested content and provides that to the user's browser in response to the request. In making the request for the advertisement, the web server sends with the request a digital certificate and possibly also information about the user, the requested content and/or the user's request details (e.g., search terms, URL). The advertising platform server decides, based at least on the digital certificate, and possibly other information which advertising content to return to the web server.

Typically, in exchange for including the advertising content, the web server operator is paid by the advertising platform operator, who is paid by advertisers who submit the viewed advertising content to the advertising platform. Naturally, paying advertisers would like some say which type of users see their advertising content and which websites present that advertising content, while website operators often don't care what advertising content gets presented, as long as they are paid to present it.

As used herein, advertisement refers to an image, an audio clip, an animation, a video clip, an executable program, or combination thereof, storable in electronic form, such as memory, and presentable (or convertible into content that is presentable) to a user of a client device or system that is also capable of obtaining and/or presenting online content to the user. Typically, a network arrangement involves one or more such client devices or systems, one or more content servers, one or more advertising platform servers, and possibly also separate structures to combine outputs of content servers and advertising platform servers.

While embodiments described herein are directed primarily to the distribution of online advertisements, it should be appreciated that embodiments can also be directed to other types of advertisements and their distribution. For example, embodiments can relate to the distribution of television advertisements based on digital certificates, radio advertisements, mobile advertisements (e.g., advertisements in the form of SMS text messages, etc.)

In a typical operation, a client device makes a request, over the Internet or other network, of a web server (or other content server) for content, and the web server (or other server) responds with the requested content combined with advertising content that the web server obtained (or obtained reference to) by requesting it from the advertising platform server.

The term “website” is often used to refer to a web server (or coherent collection of servers) and the content it serves, reflecting the user experience of “going:” to a virtual place (site) when the user causes a client device to retrieve and display some or all of that content. Therefore, it should be understood that “website” might be shorthand for a collection of network interfaced hardware and content stored or accessible thereon. Typically, but not always, the content and hardware of a website are perceived by viewers as being integrated and under control of a unitary entity, at least in part.

For example, where a server serves information about a specific company (products, contact info, hours of operation, etc.) with the content or organized with a consistent feel to various pages of that content, the servers and content are referred to as that company's website, even if the hardware is someone else's and some of that content is obtained from outside the company.

In certain embodiments, an advertising platform server includes an advertisement inventory, which stores one or more online advertisements. In some embodiments, an individual online advertisement may be associated with one or more advertisement classes or categories. For example, a first stored advertisement may be associated with a general audiences (“G” rated) class. A second stored advertisement may be associated with a restricted (“R” rated) class. While an individual advertisement may be associated with more than one class, for simplicity within the present disclosure, individual online advertisements will be discussed as being associated with a single advertisement class.

During operation of the advertising platform server, the server may receive a request for an online advertisement from a web server. In some embodiments, the received request may include a digital certificate. The digital certificate may have been previously signed by either the operator of the advertising platform server or by a trusted certificate authority. Upon receiving the request, the advertising platform server may verify the validity of the certificate. In doing so, the advertising platform server may determine whether information provided by the certificate is to be trusted. If the digital certificate is valid, the advertising platform server may thereafter use the certificate to determine one or more advertisement classes for a website associated with the requesting web server. Based on the determined class or classes, the advertising platform server may select an advertisement from its advertisement inventory. Illustratively, if the advertising platform server determines that a website is associated with an “R” rated class, the advertising platform server may only select advertisements approved for the “R” rated class. While an individual website may be associated with more than one advertisement class, for simplicity within the present disclosure, individual websites will be discussed as being associated with a single advertisement class. After selecting an advertisement, the advertising platform server may provide the advertisement to the requesting web server.

As described herein, the distribution of online advertisements based on digital certificates can be performed by appropriate systems. By requiring websites to provide digital certificates when requesting advertisements, advertisers can more efficiently and effectively manage where their advertisements appear. In particular, in order for a website to receive certain advertisements, the website must provide a valid digital certificate. Obtaining a valid digital certificate typically involves a rigorous verification process. Illustratively, a website operator may be required to submit official documentation (e.g., articles of incorporation, etc.) in order to be verified. As a result, embodiments of the present invention enable an advertiser to ensure that those websites displaying its advertisements are legitimate. Embodiments further prevent website operators from using advertisements for unapproved purposes. More specifically, because information in a digital certificate has a cryptographic binding, the information cannot be unilaterally changed by a website operator. For example, a website operator cannot unilaterally modify a digital certificate's classification from an “R” rated class to a “G” rated class. Embodiments further reduce the amount of time and resources advertisers must spend managing the distribution of advertisements. In particular, embodiments shift the distribution of advertisements from an exclusion based model to an inclusion based model. Thus, instead of selecting websites to ban from a distribution network, an advertiser can choose those websites it wishes to include. By moving to such a model and using these structures, advertisers no longer need to continuously monitor for illegitimate or rogue websites to exclude or blacklist.

Examples of the concepts and disclosures provided above will now be further explained with reference to the figures.

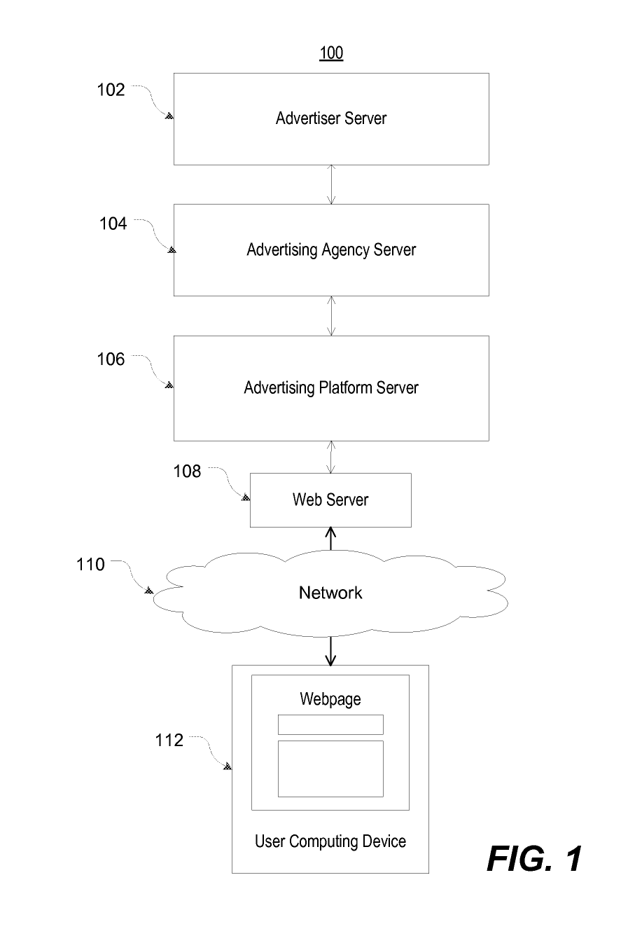

FIG. 1 illustrates a block diagram of an exemplary advertisement distribution system 100 according to one embodiment of the present invention. Advertisement distribution system 100 includes an advertiser server 102, an advertising agency server 104, an advertising platform server 106, a web server 108, and a user computing device 112. In the advertisement distribution system 100, advertiser server 102 is connected to advertising agency server 104. Advertising agency server 104 is connected to advertising platform server 106. Advertising platform server 106 is connected to web server 108, which is connected to user computing device 112 over network 110. Although the advertisement distribution system 100 of FIG. 1 shows only one advertiser server 102, one advertising agency server 104, one advertising platform server 106, one web server 108, and one user computing device 112, any suitable number of these entities (including zero) may be included. For example, the system may include multiple advertising agency servers. As another example, the system might not include any advertising agency servers. As a result, advertiser server 102 may be directly connected to advertising platform server 106.

In the present embodiment, advertisement distribution system 100 may also include software that enables communications between the various entities shown in FIG. 1. For example, communications between the entities may be facilitated by the HTTP, SSL, TLS, TCP/IP, RTP/RTSP protocols, and/or the like.

Advertiser server 102 may be implemented as one or more computer systems. For example, advertiser server 102 may be a large mainframe, a minicomputer cluster, or a group of servers functioning as a unit. In some embodiments, advertiser computer 102 may include a computer-readable medium (CRM) and a processor coupled to the CRM. In some embodiments, advertiser server 102 may transmit online advertisements to advertising agency server 104. Advertiser server 102 may also transmit online advertisements to other advertising agency servers. In some embodiments, advertiser server 102 may additionally or alternatively transmit online advertisements to advertising platform server 106. Advertiser server 102 may further transmit data regarding the websites on which a particular advertisement or a set of advertisements may be displayed. For example, advertiser server 102 may transmit data indicating that an advertisement may only be displayed on children's websites. As another example, advertiser server 102 may transmit data specifying that an advertisement may not be displayed on adult websites.

Advertising agency server 104 may be implemented as one or more computer systems. For example, advertising agency server 104 may be a large mainframe, a minicomputer cluster, or a group of servers functioning as a unit. In some embodiments, advertising agency server 104 may include a computer-readable medium (CRM) and a processor coupled to the CRM. In embodiments of the present invention, advertising agency server 104 may transmit online advertisements to advertising platform server 106. Advertising agency server 104 may also transmit online advertisements to other advertising platform servers. In certain embodiments, advertising agency server 104 may additionally or alternatively transmit online advertisements to other advertising agency servers. Advertising agency server 104 may further transmit data regarding the websites on which a particular advertisement or a set of advertisements may be displayed.

Advertising platform server 106 may be implemented as one or more computer systems. For example, advertising platform server 106 may be a large mainframe, a minicomputer cluster, or a group of servers functioning as a unit. In some embodiments, advertising platform server 106 may include a computer-readable medium (CRM) and a processor coupled to the CRM. In some embodiments, advertising platform server 106 may be configured to manage and distribute online advertisements. Advertising platform server 106, in some embodiments, may deliver online advertisements through various advertising channels including traditional online advertising channels (e.g., websites), mobile phone advertising channels, video advertising channels (e.g., streaming video systems), audio advertising channels (e.g., online radio systems), and/or the like.

In some embodiments, advertising platform server 106 may be a server of an advertising platform service. In some embodiments, advertising platform server 106 may be configured to receive online advertisements from one or more advertising agency servers and/or advertiser servers, such as advertising agency server 104 and advertiser server 102. Advertising platform server 106 may further be configured to store received online advertisements in an advertisement inventory. Advertising platform server 106 may additionally be configured to receive advertisement requests from one or more servers, such as web server 108.

In certain embodiments, the requests may include a digital certificate for a website associated with web server 108. The digital certificate may include any suitable information necessary for verifying, identifying, and classifying web server 108 and/or the website associated with web server 108. For example, the digital certificate may include identifiers (e.g., issuer information, certificate identification information), attributes (e.g., certificate number, rating), digital signatures and other types information. Illustratively, a digital certificate may include a certificate number. The number may have been assigned based on the entity that requested the certificate. For example, a number may be assigned from a specific range of numbers if the requesting entity is a large corporation rather than a small business. Based on an understanding as to the manner in which certificate numbers are assigned, embodiments can appropriately classify an associated website.

In some embodiments, the digital certificate may be formatted and include information as specified by the X.509 standard. The digital certificate may additionally or alternatively include information not specified by the X.509 standard. For example, the digital certificate may include advertisement classification information, certificate type information, or any other suitable information for classifying a website. In another variation, the digital certificates are those used to authenticate websites for other purposes, such as for securing communications.

In some embodiments, advertising platform server 106 may validate the digital certificate. Advertising platform server 106 may additionally use the information provided in the digital certificate to identify an advertisement class for a website associated with web server 108. Thereafter, advertising platform server 106 may select an online advertisement from its advertisement inventory based on the class of the website associated with web server 108. For example, advertising platform 106 may determine that the website associated with web server 108 belongs to an adult level class. As a result, advertising platform server 106 may only select online advertisements that are permitted to be displayed on websites associated with the adult class.

Web server 108 may be implemented as, for example, one or more computer systems. For example, web server 108 may be a large mainframe, a minicomputer cluster, or a group of servers functioning as a unit. In some embodiments, web server 108 may include a computer-readable medium (CRM) and a processor coupled to the CRM. In some embodiments, web server 108 may be an Internet-connected server responsive to requests at a URL designated by the operator of the web server. Web server 108 may further store web pages and other content for a website. In some embodiments, web server 108 may transmit requests for online advertisements to advertising platform server 106. In certain embodiments, an online advertisement request may include a signed digital certificate.

User computing device 112 may be any suitable device for accessing a network, such as the Internet. User computing device 112 may be, for example, a computer device, such as a desktop computer, a laptop computer, a tablet device, a mobile phone, a personal digital assistant (PDA), a gaming device, a multimedia device, a handheld device, a multi-function device, a television, a digital video recorder (DVR), and the like. User computing device 112 may include a computer readable memory (CRM), and a processor coupled to the CRM. User computing device 112 may additionally include standard computer components such as a disk drive, CD ROM drive, display (e.g., CRT or LCD monitor), display adapter, network card, wireless card, input device (e.g., a mouse, a keyboard, a touch screen LCD), and other components, subsystems, and devices. In some embodiments, the processor of user computing device 112 may be configured to execute a web browser, such as the Microsoft Internet Explorer™ browser, the Mozilla Firefox™ browser, the Google Chrome™ browser, the Apple Safari™ browser, or the Opera™ browser, etc.

In various embodiments, network 110 may include, among other possibilities, the Internet, a wide area network, a local area network, a virtual private network (VPN), or the like. In some embodiments, user computing device 112 may access network 110 through any of various wired or wireless network adaptors, such as a modem, Ethernet device, and/or hardware using one or more of CDMA, GSM, WiFi, IR, 4G, satellite link, cellular data network adaptors, and/or the like. For simplicity within the present disclosure, the example for network 110 may be the Internet, but it should be understood that it is used interchangeably with other networks in the following discussion.

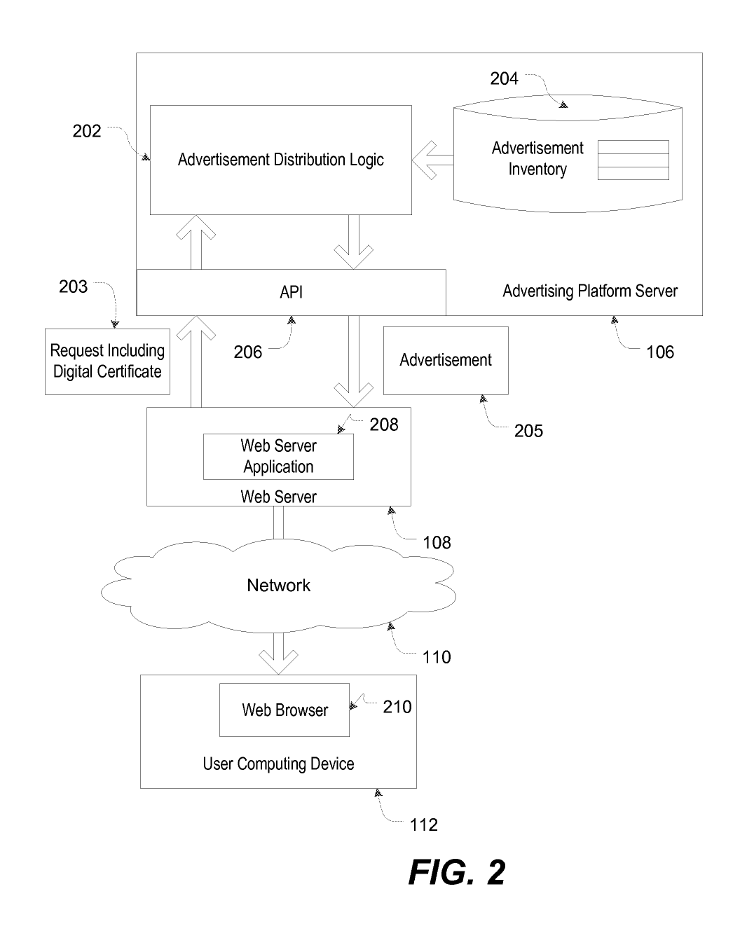

FIG. 2 illustrates a block diagram of an exemplary subsystem 200 of the advertisement distribution system 100 of FIG. 1 according to one embodiment. FIG. 2 illustrates additional details about the advertising platform server 106, web server 108, and user computing device 112.

In certain embodiments, advertising platform server 106 may include an advertisement distribution logic 202, an advertisement inventory 204, and an application programming interface (API) 206.

Advertisement distribution logic 202 may be an application program configured to receive, manage, and distribute online advertisements. In some embodiments, the advertisement distribution logic 202 may be configured to receive online advertisements, and to additionally receive requests for the advertisements. In certain embodiments, an advertisement request 203 may include, among other information, a digital certificate 205. Advertisement distribution logic 202 may, upon receiving a request, validate the digital certificate in order to confirm the information provided by the certificate. Advertisement distribution logic 202 may further access advertisement inventory 204 and select an online advertisement based on an identified advertisement class.

In some embodiments, advertisement distribution logic 202 may select an online advertisement based on additional criteria, such as contractual obligations with associated advertisers, history information, user data, user computing device attributes, contextual information (e.g., keywords, tags), geographic information, localization information, advertisement dimensions (e.g., height and width in pixels), advertisement types (e.g., pop-up ad, in-content ad, etc.), advertisement format information (Adobe Flash™ data, animated GIF, JPEG, etc.), and/or other types of data. For example, advertisement distribution logic 202 may determine a set of potential online advertisements based on the determined advertisement class. After determining the set of potential advertisements, advertisement distribution logic 202 may select an advertisement from the set based on keyword information provided in the advertisement request.

In some embodiments, advertisement distribution logic 202 may optimize the processing of a request. For example, advertisement distribution logic 202 may utilize a caching scheme to improve performance. Advertisement distribution logic 202 may also optimize the amount of times a website's digital certificate must be revalidated over a given time period.

Advertisement inventory 204 may be implemented as data stored in one or more electronic storage units (e.g., stand alone hard drives) capable of storing electronic data. In some embodiments, advertisement inventory 204 may include one or more online advertisements. In certain embodiments, the online advertisements may be received from advertising agency servers and/or advertiser server, such as advertising agency server 104 and advertiser server 102. Online advertisements may be implemented in any suitable form. For example, an online advertisement may be a static image (e.g., JPGs), an animated image (e.g., animated GIFs), an Adobe Flash™ based program, a Java based program, a Microsoft Silverlight™ based program, a piece of audiovisual media, a piece of audio-only media, an interactive computer program, and/or the like. For example, an online advertisement may be a video file advertising a special-offer to purchase a Blu-ray™ disc for the Toy Story 3™ movie.

Application programming interface 206 may be a software interface that facilitates communications between advertisement distribution logic 204 and web server 108. The application programming interface 206 may include suitable specifications for communication protocols, routines, and data structures. For example, application programming interface 206 may define the manner in which advertisement requests are to be communicated and/or the manner in which online advertisements are to be distributed.

In certain embodiments, web server 108 may include a web server application 208. Web server application 208 may be an application program configured to receive web page requests from user computing devices and to transmit web pages, including online advertisements, in response to the web page requests. Web server application 208 may be any suitable software that implements the HTTP protocol, such as a Microsoft IIS™ server, Apache Web Server™, an Oracle iPlanet™ system, etc. In some embodiments, web server application 208 may be configured to request online advertisements from advertising platform server 106.

In certain embodiments, user computing device 112 may include a web browser 210. Web browser 210 might be executed by a processor of user computing device 112. Web browser 210 may be configured to generate and transmit web page requests. Web browser 210 may additionally be configured to render web pages including online advertisements received from web server 108. For example, web browser 210 may be configured to render web pages coded in HTML, extensible markup language (XML), JavaScript, etc. so that it is viewable by a user of user computing device 112. Web browser 210 may additionally include plug-ins to render certain types of web content, such as Adobe Flash™ programs, Microsoft Silverlight™ programs, Java programs, and/or the like.

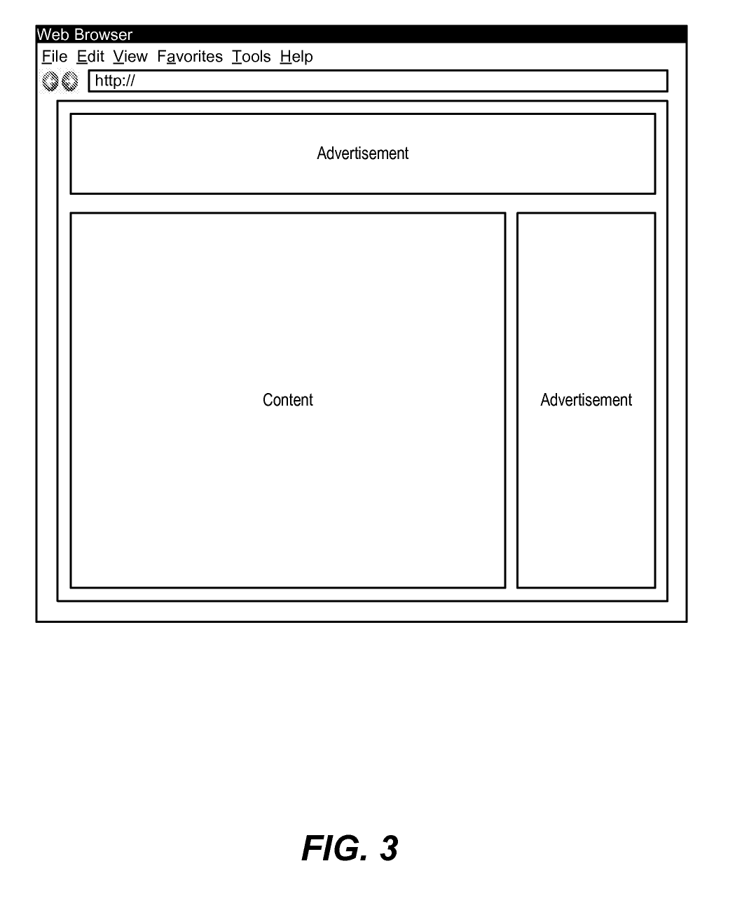

FIG. 3 illustrates an exemplary web page 300, which illustrates common placement locations of online advertisements. The designated advertisement locations may include one or more advertisements. Each advertisement location may represent a space that web server application 208 may fill with an online advertisement received from advertising platform server 106. In some embodiments, each time web page 300 is accessed, web server application 208 may send a new advertisement request to advertising platform server 106. As a result, the advertisements on web page 300 may change each time the page is accessed or refreshed.

While embodiments described herein are directed to advertisements presented via web pages, it should be appreciated that one of ordinary skill in the art could modify the invention to be directed to non-web page contexts. Other contexts may include, for example, computer games, computer programs, Internet television, Internet radio, text messages, multimedia messages, and/or the like. For instance, embodiments of the present invention may be modified, without departing from the spirit and scope of the invention, to enable a computer game server to request advertisements from an advertising platform server and to place the advertisements in an online computer game. As another example, embodiments of the invention may be modified, without departing from the spirit and scope of the invention, to enable an Internet television server to request advertisements from an advertising platform server and to overlay the advertisements over online video content.

Furthermore, while embodiments described herein are directed to the distribution of advertisements based on digital certificates, it should be appreciated that one of ordinary skill in the art could modify the invention to be directed to the distribution of advertisements based on other cryptographic and non-cryptographic based authentication mechanisms.

Examples of processes that may be used to distribute online advertisements based on digital certificates will now be described.

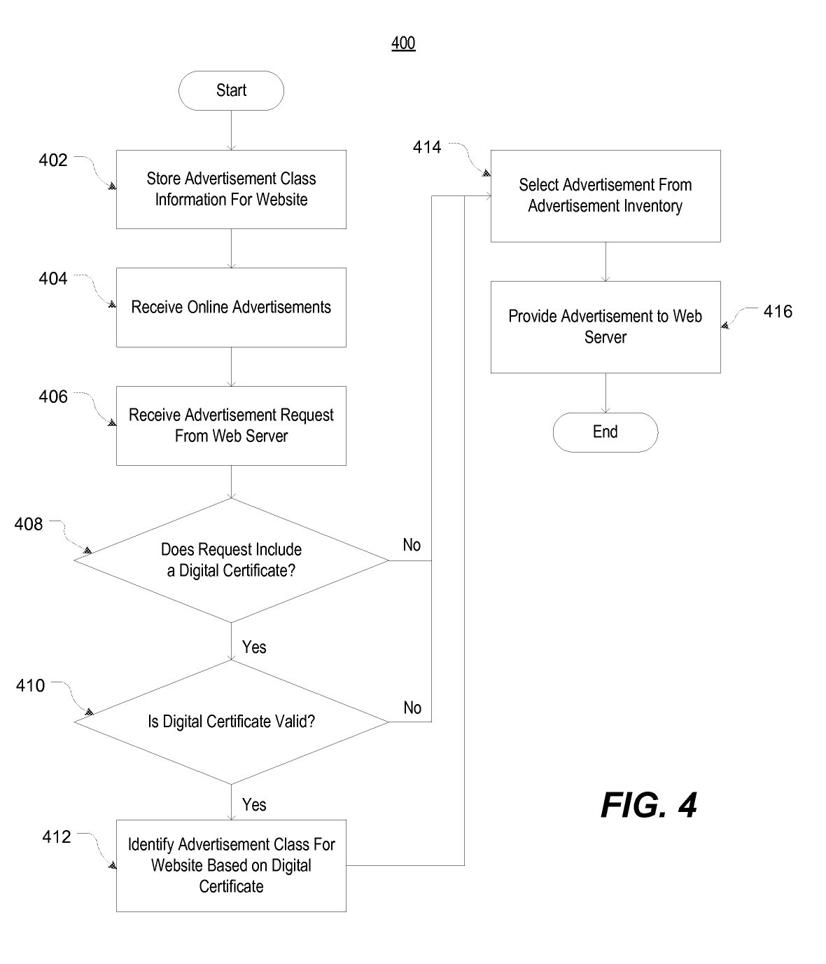

FIG. 4 is a flow diagram of a process 400 for distributing an online advertisement to a web server based on a digital certificate according to an embodiment of the present invention. Process 400 may be performed by e.g., advertising platform server 106 of FIG. 1.

At step 402, advertising platform server 106 stores advertisement class information for a website associated with web server 108. The advertisement class information may be stored in any suitable manner. For example, the information may be stored in a database or a look-up table of advertising platform server 106. In some embodiments, advertising platform server 106 may store the advertisement class information based on a website identifier. For example, advertising platform server 106 may store advertisement class information based on a website common name, domain name, IP address, and/or the like.

In some embodiments, advertising platform server 106 may have received the advertisement class information from advertiser server 102 and/or advertising agency server 104. In other embodiments, advertising platform server 106 may have received the advertisement class information from a certificate authority, such as VeriSign, Inc. In still other embodiments, the advertisement class information may have been directly inputted into advertising platform server 106 by the operators of the advertising platform server. For example, the operators of advertising platform server 106 may have obtained information regarding a website associated with web server 108 from the website's operators. Based on the information, the operators of advertising platform server 106 may determine a class for the website and thereafter provide class information for the website to advertising platform server 106.

In certain embodiments, advertising platform server 106 may not store advertisement class information for the website associated with web server 108. In such embodiments, advertisement class information may be included in the advertisement requests received from web server 108.

At step 404, advertising platform server 106 may receive an online advertisement from advertiser server 102 and/or advertising agency server 104. The online advertisement may be any suitable type of advertisement. For example, an online advertisement may be a banner ad, skyscraper ad, pop-up ad, or in-content ad. The online advertisement may additionally be implemented in any suitable form. For example, an online advertisement may be a static image (e.g., JPGs), an animated image (e.g., animated GIFs), an Adobe Flash™ based program, a Java based program, a Microsoft Silverlight™ based program, a piece of audiovisual media, a piece of audio-only media, an interactive computer program, and/or the like. In some embodiments, the received online advertisement may be stored in advertising inventory 204.

In certain embodiments, advertising platform server 106 may additionally receive advertisement class information and/or other metadata for the received online advertisement. The advertisement class information and/or other metadata may be received from advertiser server 102 and/or advertising agency server 104. The advertisement class information and/or other metadata may be received prior to, concurrently with, or following the receipt of the online advertisement.

In some embodiments, the advertisement class information may indicate the websites on which an advertisement or a set of advertisements may be presented. For example, advertising platform server 106 may receive advertisement class information for a particular online advertisement at the same time (or substantially the same time) as receipt of the advertisement. The advertisement class information may indicate that the particular advertisement is to be presented only on websites associated with a general audiences class (e.g., “G” rated). As another example, advertising platform server 106 may receive advertisement class information prior to the receipt of an online advertisement. The advertisement class information may indicate that all advertisements associated with a particular entity (e.g., an advertiser company, an advertising agency, etc.) are to be excluded from presentation on websites associated with a restricted class (e.g., “R” rated). As a result, even if a website operator had an incentive to request inappropriate advertising content based on the website's content, perhaps in an effort to increase compensation to the website operator without considering the appropriateness, it would not occur, since advertising platform server 106 checks certificates and can limit advertising content provided and paid for, based on the certificates.

In some embodiments, the advertisement class information may include criteria information for digital certificates. For example, the metadata can indicate that a particular advertisement may only be presented on a website that has provided a digital certificate of a particular type, issued by a particular certificate authority, include a particular attribute, etc.

The advertisement class information and/or other meta data received by advertising platform server 106 may be stored in any suitable manner. For instance, the advertisement class information may be stored in a database or a look-up table of advertising platform server 106.

In some embodiments, advertising platform server 106 may further receive additional information (e.g., metadata) useful in the selection of an online advertisement. For example, advertising platform server 106 may receive contextual information (e.g., keywords, tags), geographic information, localization information, advertisement dimensions (e.g., height and width in pixels), advertisement type information (e.g., pop-up ad, in-content ad, etc.), advertisement format information (Adobe Flash™ programs, animated GIF, JPEG, etc.), and/or other types of data.

At step 406, advertising distribution logic 202 of advertising platform server 106 receives a request for one or more online advertisements from web server 108. In some embodiments, web server 108 may transmit the advertisement request as part of the processing of a web page request from user computing device 112. In certain embodiments, the request may be formatted according to the specifications of application programming interface 206. For example, the request may be formatted in extensible markup language (XML). In some embodiments, the request may be securely received. For example, the request may be received over a TLS or SSL connection.

At decision 408, advertising distribution logic 202 determines if the received request includes a digital certificate. In some embodiments, a digital certificate may be issued to the operators of the website associated with web server 108 by the operators of advertising platform server 106 or by a trusted certificate authority, such as VeriSign, Inc. In embodiments of the present invention, the digital certificate may include any suitable information for verifying the identity of and determining the advertisement class for a website associated with web server 108. For example, the digital certificate may include version information, a serial number, an algorithm identifier, issuer information, validity information, subject information, subject public key information, extension data, certificate signature algorithm information, and/or a certificate signature. In certain embodiments, the digital certificate may be formatted to and include information as specified by the X.509 standard. In some embodiments, the digital certificate may alternatively or additionally include information not specified by the X.509 standard. For example, the digital certificate may include advertisement class information and/or certificate type information.

In certain embodiments, an advertisement request may further include information useful in selecting an online advertisement. For example, a request may include user data, user computing device attributes, contextual information (e.g., keywords, tags), geographic information, localization information, advertisement dimensions (e.g., height and width in pixels), advertisement types (e.g., pop-up ad, in-content ad, etc.), advertisement format information (Adobe Flash™ program, animated GIF, JPEG, etc.), and/or other types of data. Illustratively, a web page requested by user computing device 112 may discuss a recent World Series game. As a result, the advertisement request transmitted by web server 108 may indicate that an advertisement related to baseball is preferable.

At decision 410, advertising distribution logic 202 determines the validity of the digital certificate received from web server 108. For example, advertising distribution logic 202 may determine whether the digital certificate is authentic and whether or not it has been revoked.

In some embodiments, advertising distribution logic 202 may determine the authenticity of the digital certificate by retrieving a public key for the issuer (e.g., issuing certificate authority) of the received digital certificate. The issuer's public key may be retrieved from any suitable source. For example, the issuer's public key may be retrieved from a publicly accessible server over the Internet. As another example, the issuer's public key may be stored locally at advertising platform server 106. Upon retrieving the public key, advertising distribution logic 202 may use the public key to verify a digital signature included in the received digital certificate. Based on the result of the signature verification, advertising distribution logic 202 may determine whether the digital certificate is authentic.

In some embodiments, advertising distribution logic 202 may determine whether or not a digital certificate has been previously revoked by accessing a revocation list. The revocation list may be associated with the issuer (e.g., certificate authority) of the digital certificate. In certain embodiments, the revocation list may include a set of serial numbers associated with revoked digital certificates. Advertising distribution logic 202 may search the revocation list for a serial number matching the serial number of the digital certificate received from web server 108. In some embodiments, a revocation list may be stored locally at advertising platform server 106. In other embodiments, the revocation list may be stored on a public server accessible over a network, such as the Internet.

At step 412, advertising distribution logic 202 determines an advertisement class for the website associated with web server 108. Advertising distribution logic 202 may perform such a determination based on information provided by the digital certificate received from web server 108.

In certain embodiments, the digital certificate may include information specifying a class for the website associated with web server 108. For example, the digital certificate may include an attribute specifying that the website associated with web server 108 is associated with an “R” rated class.

In other embodiments, advertising distribution logic 202 may determine the class for the website associated with web server 108 by searching a database or a look-up table for a record matching an identifier or certificate type included in web server 108's advertisement request. Illustratively, advertising distribution logic 202 may search for a record based on a website common name included in the digital certificate received from web server 108. If a match is located, advertising distribution logic 202 may retrieve the matching record.

In certain embodiments, a matching database or look-up table record may include advertisement class information. The advertisement class information may include any suitable advertisement class identifiers. For example, an identifier may be numerical (e.g., 1, 2), alphanumeric (1A, ABCD, “G”, “PG-13”), descriptive (parental guidance required, all ages, general audiences, Pixar™, Disney™), and/or the like.

Advertisement classes may be organized in any suitable class structure. In some embodiments, advertisement classes may be organized in a binary structure (e.g., a website is either approved for advertisements or not). In other embodiments, advertisement classes may be organized in a structure that includes several different classes. For example, a structure may include multiple classes formatted in a manner similar to the Motion Picture Association of America (MPAA)'s movie ratings system. Illustratively, an adult website may be classified as NC-17. Likewise, a website geared for a general audience may be classified as G. As another example, a structure may include several different classes, where each class is associated with a specific entity type or name. Illustratively, a website may be associated with a Disney™ advertisement class. As such, the website may be permitted to present online advertisements for The Walt Disney Company and its affiliated companies.

At step 414, advertising distribution logic 202 selects an online advertisement to transmit to web server 108. In some embodiments, if a request does not include a valid digital certificate (e.g., a certificate was not included in the request or the digital certificate is not authenticated), advertising distribution logic 202 may select an advertisement from a set of default advertisements. The set of default advertisements may include advertisements that have no restrictions as to where they may be presented or are flagged as not requiring a digital certificate to be included with a received online advertisement request.

If a request includes a valid digital certificate, advertising distribution logic 202 may select an advertisement based on the advertisement class determined at step 412. In some embodiments, advertising distribution logic 202 may determine, based on the determined advertisement class, an initial set of candidate advertisements from the advertisement inventory 204. Illustratively, in order to determine the initial set of candidate advertisements, advertising distribution logic 202 may filter out any advertisements not approved for the determined advertisement class. After determining the set of candidate online advertisements, advertising distribution logic 202 may select an advertisement based on any suitable distribution rules, criteria, parameters, and/or the like. Illustratively, advertising distribution logic 202 may, in selecting an advertisement, consider contractual obligations with associated advertisers, history information, user data, user computing device attributes, contextual information (e.g., keywords, tags), geographic information, localization information, advertisement dimensions (e.g., height and width in pixels), advertisement types (e.g., pop-up ad, in-content ad, etc.), advertisement format information (Adobe Flash™, animated GIF, JPEG, etc.), and/or other types of data. For example, advertising distribution logic 202 may select a particular online advertisement based on the number of times the advertisement has been presented over the past week. As another example, the advertisement request from web server 108 may indicate a preference for an Adobe Flash™ based banner advertisement. The advertisement request may further indicate that the website associated with web server 108 is associated with a sports keyword. Based on this information, advertisement distribution logic 202 may select an Adobe Flash™ based banner advertisement for a Super Bowl™ DVD collection set.

At step 416, advertising distribution logic 202 provides the selected online advertisement to web server 108. The online advertisement may be transmitted to web server 108 in any suitable manner. For example, the online advertisement may be encapsulated in a response message structured according to the specifications of the application programming interface 206. In other embodiments, advertising distribution logic 202 may provide a link or location reference to web server 108. In some embodiments, the online advertisement may be securely provided to web server 108. For example, the online advertisement may be provided over a TLS or SSL connection.

It should be appreciated that the specific steps illustrated in FIG. 4 provide a particular method for distributing online advertisements. Other sequences of steps may also be performed according to alternative embodiments. For example, alternative embodiments of the present invention may perform the steps outlined above in a different order. Moreover, the individual steps illustrated FIG. 4 may include multiple sub-steps that may be performed in various sequences as appropriate to the individual step. Furthermore, additional steps may be added or removed depending on the particular applications. One of ordinary skill in the art would recognize many variations, modifications, and alternatives.

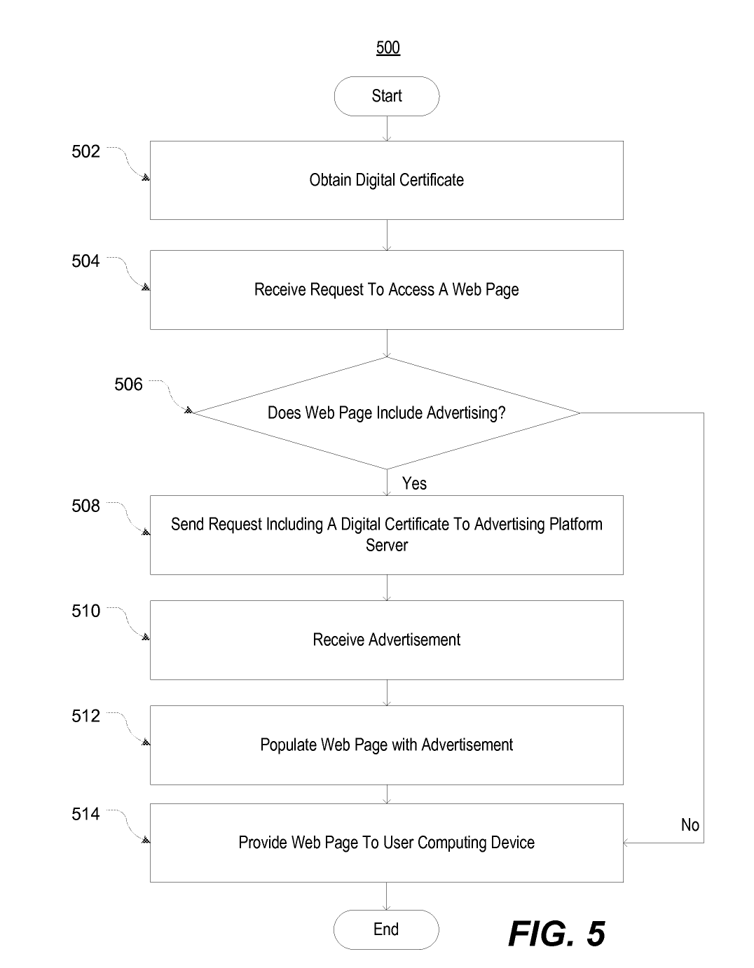

FIG. 5 is a flow diagram of a process 500 for requesting and receiving online advertisements from an advertising platform server according to an embodiment of the present invention. Process 500 may be performed by e.g., web server 108 of FIG. 1.

At step 502, web server 108 obtains a digital certificate for use with advertising platform server 106. In some embodiments, the digital certificate may be obtained directly from the operators of advertising platform server 106. In other embodiments, the digital certificate may be obtained from a certificate authority, such as VeriSign, Inc. For example, the operator of a website associated with web server 108 may send a request to a certificate authority for a digital certificate. The request may include documentation or other information confirming the identity of the operator of the website associated with web server 108. Upon receiving the request, the certificate authority may verify the identity and information of the operator of the website associated with web server 108. After verifying the identity of the operator of the website associated with web server 108, the certificate authority generates a digital certificate containing a digital signature signed by the certificate authority. The certificate authority may thereafter send the digital certificate to the operator of the website associated with web server 108, who in turn may provide the digital certificate to web server 108.

The digital certificate may include any suitable information for verifying the identity of and determining the advertisement class for the website associated with web server 108. For example, the digital certificate may include version information, a serial number, an algorithm identifier, issuer information, validity information, subject information, subject public key information, extension data, certificate signature algorithm information, and/or a certificate signature. In certain embodiments, the digital certificate may be formatted according to and include information as specified by the X.509 standard. In some embodiments, the digital certificate may alternatively or additionally include information not specified by the X.509 standard. For example, the digital certificate may include advertisement class information and/or certificate type information.

At step 504, web server application 208 of web server 108 receives a request to access a web page from user computing device 112. For example, web server application 208 may serve content (e.g., web pages) over the Internet. During operation, web server application 208 may receive a request for a stored web page from user computing device 112. The request may have been prompted by some action of a user operating user computing device 112. For instance, the user may have entered a URL address into the address bar of web browser 210 of user computing device 112. In responding to the request, web server application 208 may begin preparing the requested web page. For example, if the web page includes any scripts (e.g., PHP code, ASP code, etc.), web server application 208 may process and execute the scripts.

At decision 506, as part of the preparation of the requested web page, web server application 208 may determine whether the web page includes sections or locations reserved for online advertisements. For example, a requested web page may include a section reserved for a banner advertisement.

At step 508, web server application 208 transmits an advertisement request to advertising platform server 106. In some embodiments, a single advertisement request may request multiple online advertisements. In some embodiments, the request may be formatted according to and include information as specified by application programming interface 206. In some embodiments, the request may be securely transmitted. For example, the request may be received over a TLS or SSL connection.

In certain embodiments, the request may include the digital certificate obtained from the operators of advertising platform server 106 or the certificate authority at step 502. The digital certificate may include any suitable information for verifying the identity and determining the advertisement class for the website associated with web server 108. The request may also include user data, user computing device attributes, contextual information (e.g., keywords, tags), geographic information, localization information, advertisement dimensions (e.g., height and width in pixels), advertisement types (e.g., pop-up ad, in-content ad, etc.), advertisement format information (Adobe Flash™ program, animated GIF, JPEG, etc.), and/or other types of data. Illustratively, a web page requested by user computing device 112 may discuss the movie UP™. As such, the advertisement request transmitted by web server application 208 may indicate that an advertisement related to a Pixar™ movie is preferable.

At step 510, web server application 208 receives an online advertisement from advertising platform server 106. In some embodiments, web server application 208 may alternatively receive a link or location reference to the online advertisement from advertising platform server 106.

In some embodiments, the online advertisement may have been selected based on the digital certificate provided by web server application 208 at step 508. For example, the digital certificate included in the request may have indicated that the web server 108 is associated with a website classified as “R” rated. Accordingly, the advertisement received from advertising platform server 106 may be approved for presentation on websites classified as rated “R.”

At step 512, web server application 208 may populate a location reserved for the received advertisement on the requested web page. For example, web server application 208 may place the advertisement in an advertisement location positioned at the top of the requested web page. Web server application 208 may further perform additional processing until the requested web page is determined to be ready for transmission to user computing device 112. For example, web server application 208 may request additional advertisements, etc.

At step 514, web server application 208 may provide the requested web page to user computing device 112. Upon receiving the web page, web browser 210 of user computing device 112 may render the web page so that the page, including any advertisements, is viewable by a user. For example, web browser 210 may display an online advertisement in a position specified by the HTML code of the requested web page.

In some embodiments, the web page transmission from web server application 208 may include the online advertisements for the requested web page. In certain embodiments, the transmission may additionally or alternatively include links or location references indicating where the online advertisements for the requested web page may be accessed. For example, a transmission may indicate that an online advertisement may be accessed directly from advertising platform server 106.

It should be appreciated that the specific steps illustrated in FIG. 5 provide a particular method for requesting online advertisements. Other sequences of steps may also be performed according to alternative embodiments. For example, alternative embodiments of the present invention may perform the steps outlined above in a different order. Moreover, the individual steps illustrated FIG. 5 may include multiple sub-steps that may be performed in various sequences as appropriate to the individual step. Furthermore, additional steps may be added or removed depending on the particular applications. One of ordinary skill in the art would recognize many variations, modifications, and alternatives.

Although specific embodiments of the invention have been described, various modifications, alterations, alternative constructions, and equivalents are also encompassed within the scope of the invention. For example, the described invention is not restricted to operation with certain types of advertiser, advertising agency, web and advertising platform servers, but is free to operate with a plurality of different advertiser, advertising agency, web and/or advertising platform servers. Additionally, although the present invention has been described using a particular series of transactions and steps, it should be apparent to those skilled in the art that the scope of the present invention is not limited to the described series of transactions and steps. For example, where an element is shown as hardware performing particular actions, it might be replaced with a general purpose processor executing program instructors stored as software with the instructions corresponding to similar actions. The storage can be a computer-readable medium.

Further, while the present invention has been described using a particular combination of hardware and software, it should be recognized that other combinations of hardware and software are also within the scope of the present invention. The present invention may be implemented only in hardware, or only in software, or using combinations thereof.

The specification and drawings are, accordingly, to be regarded in an illustrative rather than a restrictive sense. It will, however, be evident that additions, subtractions, deletions, and other modifications and changes may be made thereunto without departing from the broader spirit and scope of the invention as set forth in the claims.

Any of the elements in FIGS. 1 and 2, including any servers or databases, may use any suitable number of subsystems to facilitate the functions described herein.

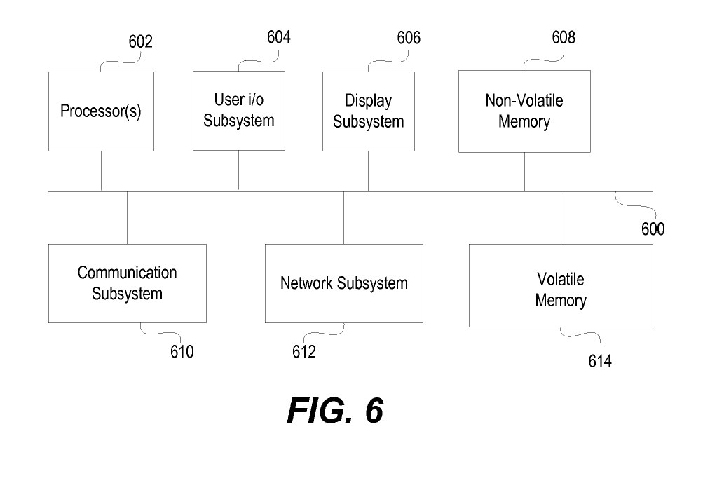

Examples of such subsystems or components are shown in FIG. 6. The subsystems shown in FIG. 6 are interconnected via a system bus 600. Additional subsystems such as a processor 602, user I/O subsystem 604, display subsystem 606, non-volatile memory 608, communication subsystem 610, network subsystem 612, volatile memory 614, and others are shown. Peripherals and input/output (I/O) devices, which couple to user I/O subsystem 604 (which may be a processor or other suitable controller), may be connected to the computer system by any number of means known in the art, such as a USB port. Communication subsystem 610 or network subsystem 612 may be used to connect the computer system to a wide area network such as the Internet, a networked resource, a mouse input device, a scanner device, a printing device, and/or the like. The interconnection via system bus allows processor 602 to communicate with each subsystem and to control the execution of instructions from non-volatile memory 608 or volatile memory 614, as well as the exchange of information between subsystems. Non-volatile memory 608 and/or volatile memory 614 may embody a computer readable medium.

What is claimed is:

1. A method for distributing advertisements over a network to which computer devices can connect, comprising:
receiving an advertisement request including a digital certificate from a requestor that is a computer server or another device that presents content and advertisements to viewers;
validating the digital certificate;
selecting an advertisement based on the digital certificate; and
providing the selected advertisement in an electronic form to the requestor.

2. The method of claim 1, further comprising receiving metadata associated with at least one advertisement.

3. The method of claim 2, wherein the selecting is further based on the metadata.

4. The method of claim 3, wherein the metadata includes advertisement class information.

5. The method of claim 1, further comprising receiving advertisement data from an advertisement distribution server, wherein the advertisement data includes at least one advertisement and metadata associated with the at least one advertisement; and
wherein the selecting is further based on the metadata associated with the at least one advertisement.

6. The method of claim 5, wherein the advertisement distribution server is associated with an advertiser or an advertising agency.

7. The method of claim 5, wherein the metadata includes digital certificate criteria information.

8. The method of claim 1, further comprising:
receiving at least one advertisement request from a second requestor that does not include a digital certificate;
selecting an advertisement from a default set of advertisements; and
providing the advertisement in an electronic form to the second requestor.

9. The method of claim 8, wherein the advertisements in the default set are flagged as not requiring a digital certificate to be included in an advertisement request.

10. The method of claim 1, wherein selecting the advertisement includes:
determining an advertisement class from a set of advertisement classes based on the digital certificate; and
selecting an advertisement approved for the determined advertisement class.

11. The method of claim 10, wherein determining the advertisement class includes identifying the advertisement class based on information provided by the digital certificate.

12. The method of claim 10, wherein determining an advertisement class includes:
determining a certificate type for the digital certificate; and
identifying an advertisement class based on the certificate type.

13. The method of claim 10, wherein determining the advertisement class includes identifying the advertisement class based on classification information provided by the digital certificate.

14. The method of claim 10, wherein an at least one class in the set of advertisement classes is based on the Motion Picture Association of America movies ratings system.

15. The method of claim 1, wherein the selecting further includes selecting based on information about a website with which the digital certificate is associated.

16. The method of claim 1, wherein the digital certificate is formatted according to the X.509 standard.

17. A computer-readable storage medium containing program instructions that, when executed by a computer system, causes the computer system to execute a method for distributing advertisements over a network to which computer devices can connect, comprising:
receiving an advertisement request including a digital certificate from a requestor that is a computer server or another device that presents content and advertisements to viewers; and
validating the digital certificate;
selecting an advertisement based on the digital certificate; and
providing the selected advertisement in an electronic form to the computer server.

18. The computer-readable storage medium of claim 17, wherein the method further comprises receiving advertisement data from an advertisement distribution server, wherein the advertisement data includes at least one advertisement and metadata associated with the at least one advertisement; and
wherein the selecting is further based on the metadata associated with the at least one advertisement.

19. The computer-readable storage medium of claim 18, wherein the advertisement distribution server is associated with an advertiser or an advertising agency.

20. The computer-readable storage medium of claim 18, wherein the metadata includes digital certificate criteria information.

21. The computer-readable storage medium of claim 17, wherein the method further comprises:
receiving at least one advertisement request from a second requestor that does not include a digital certificate;
selecting an advertisement from a default set of advertisements;
providing the advertisement in an electronic form to the second requestor.

22. The computer-readable storage medium of claim 21, wherein the advertisements in the default set are flagged as not requiring a digital certificate to be included in an advertisement request.

23. The computer-readable storage medium of claim 17, wherein selecting an advertisement includes:
determining an advertisement class from a set of advertisement classes based on the digital certificate; and
selecting an advertisement approved for the determined advertisement class.

24. The computer-readable storage medium of claim 23, wherein determining an advertisement class includes:
determining a certificate type for the digital certificate; and
identifying an advertisement class based on the certificate type.

25. The computer-readable storage medium of claim 23, wherein determining the advertisement class includes identifying the advertisement class based on identification information provided by the digital certificate.

26. The computer-readable storage medium of claim 23, wherein determining the advertisement class includes identifying the advertisement class based on classification information provided by the digital certificate.

27. The computer-readable storage medium of claim 17, wherein the digital certificate is formatted according to the X.509 standard.

28. A method for requesting advertisements, the method comprising:
sending an advertisement request, wherein the advertisement request includes a digital certificate; and
receiving an advertisement, wherein the advertisement is selected based on the digital certificate.

29. The method of claim 28, wherein the digital certificate includes information relevant for selecting an advertisement, and wherein the digital certificate is received from a certificate authority.

30. The method of claim 28, wherein the digital certificate is signed by a certificate authority.

31. A computer-readable storage medium containing program instructions that, when executed by a computer system, causes the computer system to execute a method comprising:
sending an advertisement request, wherein the advertisement request includes a digital certificate; and
receiving an advertisement, wherein the advertisement is selected based on an advertisement class.

32. The computer-readable storage medium of claim 31, wherein the digital certificate is signed by a certificate authority.

33. The computer-readable storage medium of claim 31, wherein the advertisement class is determined based on the digital certificate.
